(19) United States
(12) Patent Application Publication
(10) Pub. No.: US 2005/0055280 A1
(43) Pub. Date: Mar. 10, 2005

(54) Method, system and apparatus for internet-based sales generation

(76) Inventor: Gabrielle Jeans, Mississauga (CA)

Correspondence Address: Miller Thomson LLP, Suite 2500, 20 Queen Street West, Toronto, ON, M5H 3S1, CA

(21) Appl. No.: 10/656,115

(22) Filed: Sep. 8, 2003

(51) Int. Cl. G06F 17/60

(52) U.S. Cl. 705/26

(57) ABSTRACT

A system, computer program product and method is provided for generating sales via the Internet. The system includes a server application executed on a server computer. The server application includes a web publication facility that enables sales agents via an administration interface to build and publish customized web pages, based on a series of web page templates accessible via the server application. Contact data of customers and potential customers is provided to the server application, including by operation of the customized web pages that collect the contact data. The contact data is stored to a database linked to the server computer. The database provides access to sales agents to only their contact data. The server application also enables the sales agents to share data if they instruct the server application to do so. The server application also includes a sales tool facility and a communication facility. The sales tool facility enables the construction via the administration interface of a variety of documents and communications based on a series of sales tool templates. The sales tool templates are designed to generate sales based on the target audience of the subscribing sales agent. The communication facility also enables the documents and communications to be distributed electronically using the contact data. The computer program product consists of the server application, as well as a computer application resident on a personal computer, in another embodiment of the invention. The method consists of promoting sales generation via the Internet by publishing a customized web page using the web publication facility, collecting contact data, and communicating documents and communications designed for the sales agent's target audience by means of the sales tool facility.

### FIELD OF THE INVENTION

This invention relates in general to a method, system and apparatus for managing sales generation via the Internet. More particularly, this invention relates to operation of a sales agency business via the Internet.

### BACKGROUND OF THE INVENTION

Numerous prior solutions for generating sales via the Internet are known. This includes solutions directed in particular at generating sales in relation to a real estate agency business.

The use of the Internet to generate sales in the real estate industry is known. Numerous agencies utilize web sites for lead generation. These web sites are provided in a manner that is well known. Tools for updating web sites are also known such as NETSCAPE COMMUNICATOR™ and the like. These updating tools generally require familiarity with the operation thereof.

A large number of specialized software tools are also known for assisting sales generation in a number of commercial areas. For example, with respect to the real estate industry, a number of tools are listed in the “Complete Real Estate Software Catalog” of Z-Law Software, Inc. Other special tools for the real estate industry include “The Commission Companion”, products of “PREP Software”, and “REA/L Estate Analysis Software”, “Top Producer” by Top Producer Systems.

Customer relationship management (“CRM”) solutions are also well known, including web-based CRM products. For example, GOLDMINE™ provides a web-based CRM solution, including templates directed at the real estate industry.

Web portals for accessing a plurality of web sites corresponding to real estate agents managing specific listing properties are also known.

There are a number of disadvantages to the prior art solutions. First of all, in any sales oriented industry where a sales agent is required to complete a number of tasks in order to generate sales, a suite of tools assisting with these tasks in a synergistic manner is required. The prior art solutions generally focus on providing tools for facilitating individual tasks, rather than an integrated suite of tools. This approach has a number of disadvantages. Firstly, the sales agent is required to learn to use multiple software tools based on different user logic. This results in barriers to adoption of the software tools and increased training costs. Secondly, there is generally common data required for the operation of more than one of such software tools. Even with export/import utilities, the absence of an integrated suite of products poses challenges in achieving optimal use of the common data for the purpose of sales generation.

In addition, none of the prior art solutions provides adequate tools for ensuring customer satisfaction. The success of sales agents, including real estate agents, is dependent on not only attracting customers, but also on keeping the customers apprized of the sales agent's efforts made on the customer's behalf. Prior art solutions do not adequately address this requirement.

The cost of obtaining all of the resources discussed above, namely a up to date web site for the purpose of attracting customers, and the various software tools for operating the sales agency business, including CRM tools and the like is prohibitive. There is a need for a solution that enables cost sharing by a plurality of users while providing security of important data, including customer lists and the like.

Another disadvantage of prior art solutions is that they do not provide an integrated solution that incorporates the key functions relates to sales generation: product/service promotion and customer relationship management.

Another particular disadvantage prior art CRM solutions is that they are not readily customizable to the particular processes related to sales generation. Accordingly, prior art CRM solutions typically contain a large number of features that are not related to the key CRM aspects of sales generation processes. For this reason, the CRM solutions tend to be cumbersome and somewhat complicated to use.

There is a need therefore for a sales generation system, computer program product and method that allows the management of sales generation over the Internet efficiently and cost effectively. There is a further need for a sales generation system, computer program product and method that enables building a customer list, promotion of goods/services via a web site, and CRM, linked to a customer database. There is a still further need for a real estate sales generation system, computer program product and method that allows the management of sales generation over the Internet, efficiently and effectively.

### SUMMARY OF THE INVENTION

It is an object of the present invention to provide a system, computer product and method for generating sales over the Internet by means of customizable web sites, a sales tool facility and a database connected to the Internet that permits a customer to remotely store and access their data on a secure basis.

Another aspect of the present invention is that the database is associated with a database management facility that permits Sales Agents to share data selectively with one another for a common marketing purpose.

A still other aspect of the present invention is a sales tool facility which provides means for creating documents and communications on an automated basis geared to a particular sales generation process.

### BRIEF DESCRIPTION OF THE DRAWINGS

A detailed description of the preferred embodiment(s) is(are) provided herein below by way of example only and with reference to the following drawings, in which:

FIG. 1 is a system resource diagram in accordance with one embodiment of the present invention.

FIG. 2 illustrates the resources of the software product of the present invention, in accordance with one embodiment thereof.

FIG. 3 illustrates the resources of the system of the present invention in an “OFFICE” implementation thereof.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

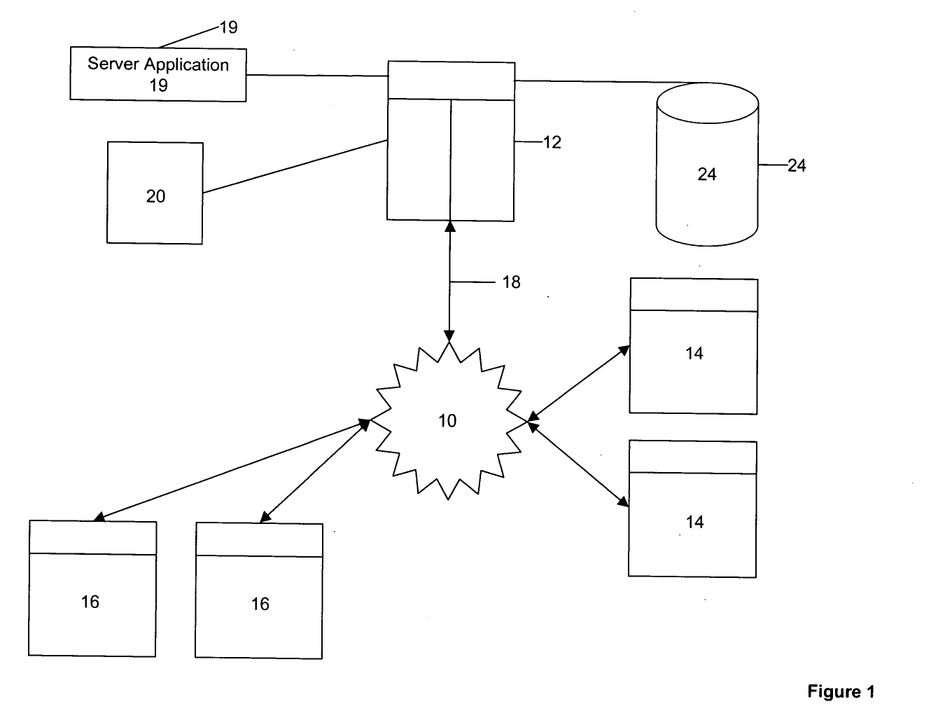

Referring to FIG. 1, there is illustrated a system resource diagram illustrating one aspect of the system of the present invention. By means of the Internet medium 10, Internet server 12 is made accessible to one or more “Sales Agents” 14 and also one or more “Users” 16.

It should be understood that in the present invention the “Sales Agent” is generally a sales agent engaged in the sale of goods, services, or a combination of goods or services.

One aspect of the present invention is to provide a customized web site 20 to each Sales Agent, as particularized below. The web site 20 is directed to “Users” 16 who are simply computer users connected to the Internet 10 by means of any known connection. “Users” include “Customers” of Sales Agents, and “Clients” in the sense of individuals, corporations or other entities to whom the Sales Agent sells goods, services or a combination of goods and services on behalf of Customers.

It should be understood that the term “Sales Agent” is not used in this description in any technical sense, for example, to imply independence from the Customer. “Sales Agent” may include an employee of a Customer engaged in the sale of goods or services of the Customer and is meant to convey that the activities of the individual, corporation or other entity who is a “Sales Agent” includes facilitating and concluding sales. For the sake of clarity therefore, “Sales Agent” as used herein may also include an individual, corporation or other entity who facilitates and concludes sales on his/her own behalf, rather than on behalf of somebody else, i.e. a Customer.

It should be further understood that the description of the present invention draws principally on the example of the real estate industry to illustrate the operation of the present invention, however, the benefits of the present invention are realized in numerous other industries such as the insurance industry, financial industry and so on.

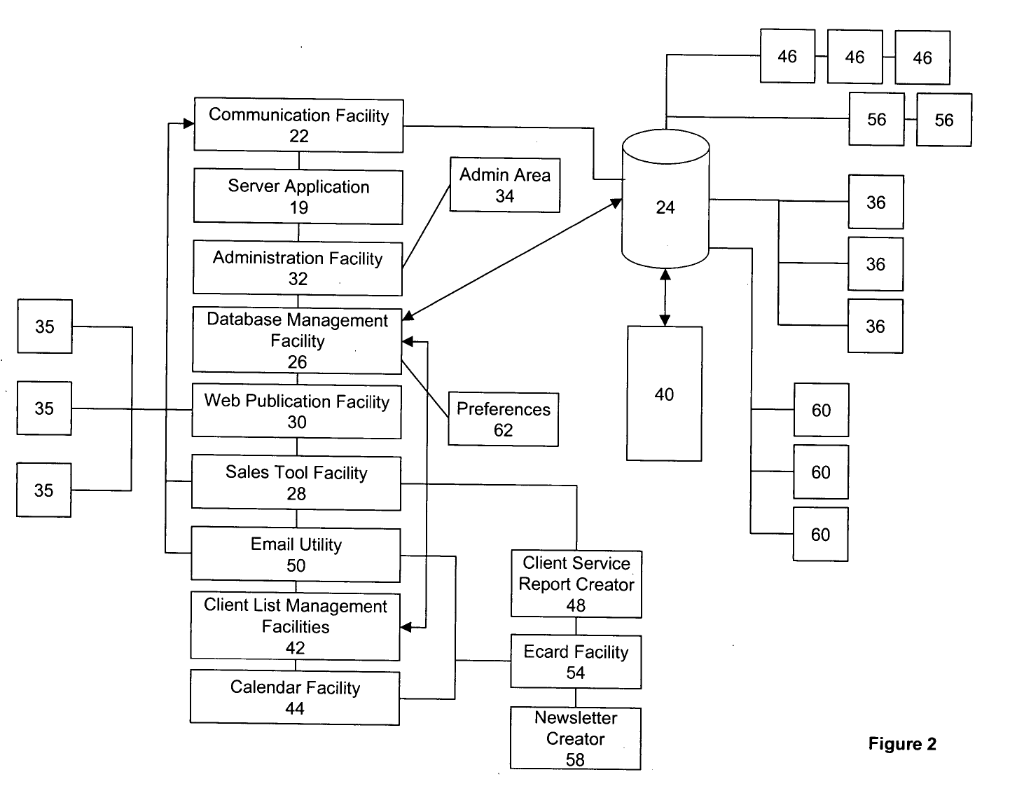

As illustrated in FIG. 1, Internet server 12 is linked to the Internet 10 via an Internet connection 18, and further linked to a server application 19. And, as illustrated in FIG. 2, the server application 19 includes a communication facility 22, database 24, database management facility 26, sales tool facility 28, web publication tool 30, and administration facility 32, as well as further facilities described below.

It should be understood that the present description explains the invention by reference to a series of different facilities. Each of these facilities describes a system or computer program function. The facilities may be part of another utility, or in fact be comprised of several computer utilities in practice.

The functionality of each of these elements of Internet server 12 is discussed below. It should be understood, however, that the present invention encompasses providing the Internet environment described herein through the auspices of a variety of types of Internet connections, whether LAN connections, fiber optic cable connections, wireless Internet connections, and so on. It should also be understood that the present invention encompasses providing the Internet server 12 through any number of equivalents including any combination of hardware and software which enables the functions of this invention to be provided on the Internet, or any other inter-connected network of computers. Also, database 24 and database management facility 26 can be provided by a wide array of custom or off-the-shelf database and database management products. In addition, said database management facility 26 can also incorporate a number of tools for identifying and manipulating relevant data, such as known knowledge management tools. The present invention also contemplates interoperability of database 24 and database management facility 26 with other networks such as a corporate LAN, for example, to access from such LAN the data contained in database 24 or to make changes to the settings of database management facility 26 on a remote basis.

Administration facility 32 is a known tool that is controlled by the operator of Internet Server 12 for controlling access to the resources of the Internet server, which are particularized below. In one embodiment of the administration facility 32, Sales Agents 14 who have obtained the right to access the Internet Server 12 are assigned by the operator using the Administration Facility 32 a username/password combination, such that a Sales Agent 14 is given the ability to log on to the Internet Server 12 and access the resources of the Internet Server 12 dedicated to Sales Agents 14 particularized below, using a known Internet browser. In particular, the Administration Facility 32 controls access to the “ADMIN” area 34 of back-end of the Internet Server 12.

Once Sales Agents are logged on to the Internet Server 12, and have accessed the “ADMIN” area 34, they can access the functions of the web publication tool 30. This is generally a known web-based web publication tool 30 for creating customized sales oriented web pages 35. A series of web templates 36 is provided to the database 24 to this end. One aspect of the present invention is that these web templates are updated regularly to include templates that are likely appeal to the target audience of the sales generation activities of the Sales Agents.

The web publication tool 30 permits the web templates 36 to be populated with data, including text and images supplied, or inputted by Sales Agents, in a manner that is known, including for example by means of web forms. For example, the web publication tool 30 permits Sales Agents to upload images of houses (in a real estate implementation) or products.

Web publication tool 30 also includes a series of known tools for selecting and/or altering the look and feel of the customized web pages 35, including for example having regard to fonts, colors, web formats, web layouts, navigation etc. For example, the web publication tool 30 enables the Sales Agents to change banners, change content, add custom pages, add links, change the front page design, change colors, all by operation of the web publication tool 30. One aspect of the present invention is that the web creation tools provided by the web publication tool 30 are updated regularly by the operator of the Internet server 12 to incorporate the features/colours/design aspects that are considered best-of-breed in regard to the sales generation process.

While web publication tools are well known, one aspect of the embodiment of the present invention is that web publication tool 30 is provided using an interface that is particularly easy to use. It should be understood that the creation of web sites is not generally within the scope of the expertise of the typical Sales Agent. The web publication tool 30 of the present invention therefore includes an easy to use web interface that permits the selection of web site features, and immediate display of a “PREVIEW” of a web site based on the selected features. This permits the Sales Agents design web sites dynamically. It has been discovered in working with Sales Agents that this is a particularly effective way in enabling Sales Agents to create their own web sites.

It is important that the web publication tool 30 be easy to use to promote ease of adoption of the present invention by Sales Agents who may not be familiar with the use and operation of such tools.

It should be understood that web publication tool 30 provides means for easily updating the customized web pages 35 on a regular basis. This feature is provided in a manner that is known.

Yet another aspect of the web publication tool 30 of the present invention is that it assists Sales Agents to establish search engine positioning for their site, based on best practices. This includes for example creation of individual title tags and description tags for each page on their site. One of the aspects of the present invention is that the server application 19 described provides access to best practices around aspects of promotion of goods/services over the web such as search engine positioning.

Once a Sales Agent has inputted the various text and graphic elements of a customized web page 35 using the web publication tool 30, the web publication tool 30 is adapted to publish the customized web page 35 to the Internet at the URL provided by the Sales Agent, by selection of a “PUBLISH WEB SITE” button or equivalent. The present invention contemplates that the operator of the Internet Server 12 will host the customized web pages 35 or some other Internet hosting services provider is selected by the Sales Agent. In either case, the web publication tool 30 provides means for creating and publishing to the Internet sales oriented customized web sites 35.

It should be understood that another aspect of the present invention is that the use of the resources of the Internet Server 12 by Sales Agents 14, including the web publication tool 30, permits the cost of new features thereof, including new and improved industry specific web templates 36 to be shared among several Sales Agents 14.

One key aspect of the web publication tool 30 is that it builds into the customized web page 35 key web site functions that are linked to the sales generation process over the Internet. One such web site function is the ability to use the customized web page 35 to build customer lists. This is achieved using a web form that visitors to the customized web page 35 can fill out, linked to information that such visitors are likely to be interested in. For example, in the context of real estate, visitors to the customized web page 35 are offered certain data provided by the Internet server 12 such as “Free Real Estate Information” in exchange for their contact information. This contact information is automatically stored to the database 24.

Another aspect of the present invention is that it enables communication between the Sales Agent and its customers. This is facilitated by the tools such as the email utility 50 described below. But, in addition, the web publication tool 30 enables Sales Agents to select and thereby establish a feature of their customized web pages 35 whereby customers or potential customers can use the customized web pages 35 to request an appointment with the Sales Agent. For example, in the real estate implementation of the present invention, the type of appointment can also be selected such as “LISTING APPOINTMENT”, “SHOWING”, “FOLLOW-UP CALL”, “PRICE REDUCTION” or “HOME EVALUATION”.

Another aspect of the present invention the database management facility 26. The administration facility 32 enables the Sales Agent to access key functions of the database management facility 26 particularized below. For example, the database management facility 26 permits the Sales Agent to import to the database 24 the contents their client list 40 from a remote computer (not shown) in a manner that is known. The client list 40, for the sake of clarity, may also include client prospects in addition to established clients. The database management facility 26 also permits new entries to the client list 40 to be collected by means of the customized web site 35. For example, in a particular embodiment of the present invention, the customized web site 35 will request visitors to the site to provide their contact information through a web form, in a manner that is known. This information is automatically added the client list 40 stored to the database 24 in a manner that is known.

A still further aspect of the agent database management facility 38 is that it enables clients to input through via a user interface provided by the Internet server 12 new contact information to the client list 40.

The data that is contained in the client list 40 is of crucial importance to Sales Agents. Another aspect of the present invention is that the database 24 and the known database management facility 26 are provided in a manner that Sales Agents can access only their own data. Another aspect of the present invention, however, is that database management facility 26 provides the ability for the Sales Agent to elect to share specific data with other Sales Agents. Another aspect of the database management facility 26 is that it enables Sales Agents to access and download their client list 40 to a remote utility such as OUTLOOK™ resident on their personal computer.

For example, in the real estate industry implementation of the present invention, two Sales Agents may be willing to share images of listed properties and related listing information included at their customized web sites 35 in order to enhance the content of their respective customized web sites 35. Similarly, in certain specific implementations, two Sales Agents may agree to share certain portions of their client list 40 for defined joint initiatives. The database management facility 26 of the present invention permits the Sales Agent to either provide open access to certain of their data stored to the database 24, or to share certain of their data with specific Sales Agents. This particular aspect of the present invention promotes flexibility which in turn permits efficient arrangements to be entered into in regard to the use of and access to data. Specifically, this flexibility permits Sales Agents to define the balance to be struck that is appropriate in the particular circumstances between maintaining confidentiality of data, and sharing data for a common purpose, thereby promoting sales. This in turn enables the development of sales generation processes.

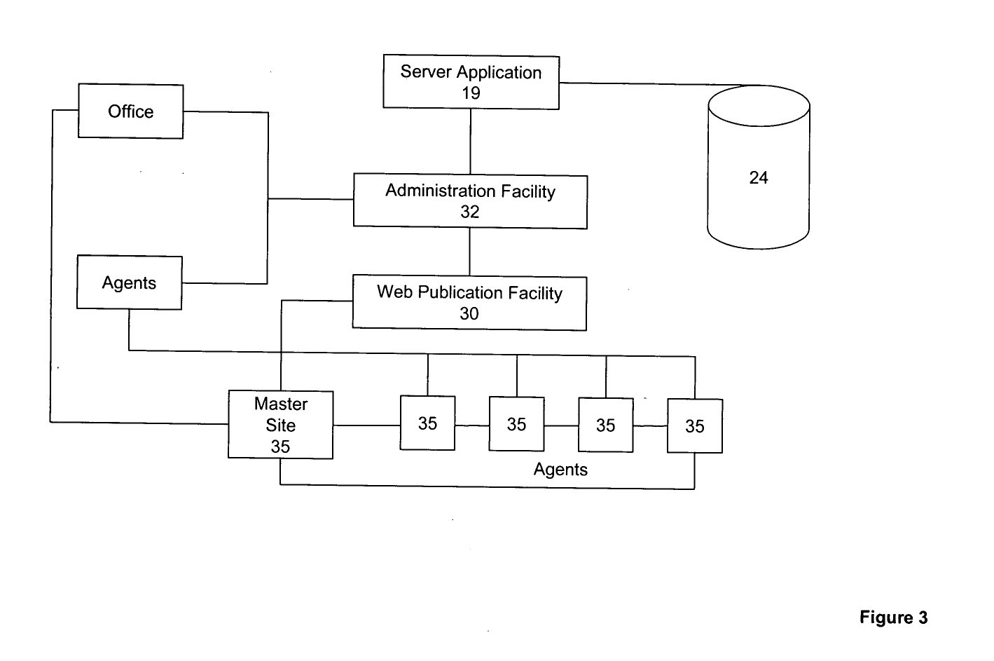

One particular aspect of the present invention is an “OFFICE” version of the solution described herein, best understood by reference to FIG. 3. This enables an office, company or partnership having a plurality of Sales Agents to operate its own web site provided in accordance with the solution described. The administrator of the OFFICE recognized by the Internet server 12 can define within the database 24, by operation of the administration facility 26, data that is to be shared by Sales Agents that are part of the OFFICE, and in some cases data that is to be controlled by each particular Sales Agent.

In one particular implementation of the present invention, the web publication tool 30 enables the OFFICE administrator to create a “network” of customized web pages 35. The network of customized web pages 35 includes a Master Site that is linked to the OFFICE, and then enable Sales Agents to within defined parameters (e.g. standard style and certain standard content defined by the OFFICE administrator) to create their own customized web pages 35 linked with individual Sales Agents, and connected to the Master Site. For example, one aspect of this network of customized web pages is that information regarding the product or service offerings (common to all Sales Agents, shown as “Common Data” in FIG. 3) is automatically published to the customized web pages 35 of individual Sales Agents. As explained above, the present invention enables the OFFICE administrator to also update the information on an ongoing basis and publish it to the customized web pages of the Sales Agents, by operation of the web publication tool 30.

Another aspect of the database management facility 26 is a client list management facility 42. The client list management facility 42 of the present invention is a known web-enabled client list management facility, such as those found in GOLDMINE™ or other CRM solutions. The client list management facility 42 permits Sales Agents to organize their client list 40, in accordance with their preferences, for example, by creating one or more contact lists for different sales purposes. It is contemplated that the client list management facility 42 of the present invention includes the various features ordinarily associated with this type of tool.

The client list management facility 42 can also be used, in a manner that is known, to print labels.

It should also be understood that the present invention contemplates that the client list 40 include various information regarding the clients including their contact information (mailing address, fax number, phone number, email address), but also other data that may be relevant to the sales process (such as product requirements, price requirements, name of spouse, birthday and so on).

Another aspect of server application 19 is a known web-enabled calendar facility 44 that interfaces with any calendar information provided to the client list 40 to display such information in a known calendar interface. The calendar facility 44 also permits Sales Agents to schedule various sales initiatives such as trade shows, open houses, phone calls, sending of an email and the like. The calendar facility 44 has a planning function, but also a historic function, in the sense of recording sales activities that have occurred (further explained below). To this end, in one particular embodiment of the present invention, the calendar facility 44 provides means for confirming that a Sales Agent has actually engaged in a particular scheduled sales initiative, i.e. the sales initiative was not cancelled, postponed or missed. For example, a message could be displayed to the Sales Agent, or sent to the Sales Agent, by means of the communication facility 22, asking the Sales Agent to confirm the occurrence of the particular sales initiative.

Another aspect of the present invention is the sales tool facility 28. The sales tool facility 28 also cooperates with the database 24 to access a series of sales tool templates 46. When a Sales Agent logs into the “ADMIN” area 34 of the Internet Server 12, the Sales Agent is permitted to engage the sales tool facility 28 to create one or more specialized sales tools used in the course of the Sales Agent's sales activities. Specifically, the sales tool facility 28 is one or more known utilities adapted to create a series of communication tools by customizing the sales tool templates 46 in a manner that is known. Customization can be obtained by input from the Sales Agent, for example, by means of a web form, in a manner that is known, or on an automated basis by populating a sales tool template 46 with data provided by the Sales Agent, for example via a web form, or contained in the database 24, or a combination of the two.

The sales tool facility 28 is best understood as a utility that enables the creation of sales generation related documents or communications rapidly, based on a plurality of sales tool templates 46. One of the benefits of the present invention is that the operator of the Internet server 12 can invest in keeping up to date, and in fact innovating, in the area of sales generation best practices. The documents or communications (as illustrated below) defined by these best practices are then distributed to the Sales Agents for customization and incorporation day-to-day in their sales generation processes.

For example, in a particular embodiment of the present invention, in operation in the real estate industry, the sales tool templates 46 include one or more “LISTING PRESENTATION” or “BUYER PRESENTATION” template. A “LISTING PRESENTATION” or “BUYER PRESENTATION” is generally a presentation prepared for a buyer, reviewing the various features of a particular piece of property. The sales tool facility 28 allows the Sales Agent to select a particular property associated with the Sales Agent from the database 24, in co-operation with the database management facility 26, in a manner that is known, and merge the data with a particular sales tool template 46 (having regard to form, text, etc.). Accordingly, a customized “LISTING PRESENTATION” is created and displayed to a Sales Agent in a browser.

This particular feature of the present invention, permits a Sales Agent to create a best-of-breed communication tool, for example, a FLASH or other multi-media animation presentation. This particular example illustrates one of the benefits of the present invention in that it permits Sales Agents, to obtain high quality sales tools easily, and at a reduced cost. This is because if the Sales Agent obtained the software tools to provide a “LISTING PRESENTATION” in FLASH, for example, or had such a “LISTING PRESENTATION” developed by a third party, the cost would be prohibitive. Also, familiarization with the functions of the software tools needed to create such a sales tool. It should be understood that Sales Agents can also add photo images, text, or slides to the “LISTING PRESENTATION”.

Another example of the operation of the sales tool facility 38 is that it enables the creation of a “Feature Sheet” based on data provided to the database 24, and in some cases data requested from the Sales Agent also. For example, in the real estate implementation of the present invention, a “Property Feature Sheet” would be generated automatically by the server application 19, for example based on a request made via the customized web page 35. Other examples of sales generation related documents created by the sales tool facility 38 in the real estate implementation of the present invention include “Open House Feature Sheets”, “Just Listed Feature Sheets” and the like. This can then be distributed using the email utility 50.

Another aspect of the present invention is an email utility 50 provided by the communication facility 22. Specifically, email utility 50 is a known web mail utility that is accessed by Sales Agents via their customized web page 35. The email utility 50 is connected with the database management facility 26, such that for example, email recipients can be selected from the Sales Agent's client list 40.

Another feature of the sales tool facility 28 is a client service report creator 48. Client service report creator 48 permits the Sales Agent to select amongst a number of templates for client service reports (as to form and substance) included in the sales tool templates 46. The text associated with a particular client service report 52 can be inputted by a Sales Agent, for example, using a known web form, or more importantly obtained by reference to calendar data provided to the calendar facility 44. In particular, the client service report creator 48 is adapted to create a client service report detailing the various sales initiatives undertaken by the Sales Agent for a particular Customer, by reference to the calendar facility 44. If the report so provided is not complete, in a particular embodiment of the present invention, the Sales Agent is afforded an opportunity to complete the list of sales activities by providing text input, for example, by means of a web form in a manner that is known. For example, the client service report would reflect appointments between the Sales Agent and a customer.

Another aspect of the present invention is that the administration facility 32 enables Sales Agents to (in cooperation with web publication tool 30) enables their customers to log in (through a known interface) to the Internet server 12 so as to obtain client service reports.

Yet another feature of the present invention is a sales communication facility or e-card facility 54 provided by the sales tool facility 28 and associated with the email facility 50. The database 24 also includes a plurality of e-card templates 56, for example, e-cards specific to the particular industry of the Customer. In a particular embodiment of the present invention, for example, in operation in the real estate industry, a representative set of e-card templates 56 may include e-card templates having the following headings: “JUST LISTED”, “JUST SOLD”, “FREE EVALUATION”, “THANK YOU”, “SEASONS GREETING” and “OPEN HOUSE”.

The e-card templates 56 may include various graphical enhancements such as animation and the like.

The e-card facility 54 permits the Sales Agent to select an e-card template 56, and if required customize the data contained in the template, and then by initiating the email facility 50, send the e-card to recipients selected from client list 40. The e-card facility 54 cooperates with the calendar facility 44 such that the Sales Agent can instruct the Internet server 12 to send specific e-cards to selected recipients on certain days of the year, provided to the calendar facility 44. In this way, for example, the Sales Agent can define automated follow-up messages.

A still other feature of the present invention is a newsletter creator 58 which permits the Sales Agent to access from the database 24, and display in a browser, one or more newsletter templates 60. The newsletter templates 60 can then be customized either by merging the newsletter templates 60 with data contained in the data associated with the Sales Agent in the database 24, or inputting data for example using a web form, in a manner that is known.

The newsletter can either be emailed to customers using the email facility 50, or printed and mailed etc.

Another feature of the customized web page 35 of the present invention is to provide a built-in search engine that permits Users to select data of the Sales Agent associated with the customized web page 35. The agent data management tool 38 permits the Sales Agent to determine which of its data is searchable in this fashion. As stated earlier, the database management facility 26 is further adapted to permit sharing of data between a plurality of Sales Agents. For example, in a particular embodiment of the present invention, in operation in the real estate industry, Sales Agents are permitted to share listings data such that Users may search listings via a particular customized web page 35 which may actually originate from a Sales Agent not associated with that customized web page 35.

The present invention also contemplates interfacing with a known Internet-based mapping tool for attaching geographic information where required. For example, the email facility 50 can be engaged to attach, when sending out an “OPEN HOUSE” e-card, geographic information regarding the location of the house at issue from www.mapquest.com.

Another aspect of the present invention is that it permits automation of sales initiatives and thereby facilitates the sales process. For example, the database management facility 26 provides means to engage the sales tool facility 28 to automatically build, for example, a “PRODUCT FEATURE PAGE” upon entry of a new product to the data in the database 24 that is particular to a Sales Agent. This then engages the Sales Agent to immediately send the resultant “PRODUCT FEATURE PAGE” to its customers, for example, by using the email facility 50.

The database management facility 26 also includes a preferences facility 62 which permits certain features of the present invention to either be enabled to disabled, or the parameters of certain features (if any) to be set. This permits alarms to be set for certain events in co-operation with the calendar facility 44, and also to engage the sales tool facility 28 to automatically build certain sales tools, as described above.

Another aspect of the web publication tool 30 described is that it permits the Sales Agent to incorporate rapidly into its customized web page 35 other features linked to the sales generation process such as a “Client Testimonial” feature by the click of a mouse.

Yet another aspect of the present invention, is that the server application 19 of the described above provides access to training for Sales Agents as to how to use the present solution effectively to promote sales generation. This is provided by providing access to a series of documents, online seminars and the like on this topic, via a web interface.

Another aspect of the present invention, is that only the various Sales Agents or OFFICES will have access to their own data on the database 24. However, the Internet server 12 can enable the different Sales Agents and OFFICES to communicate if this is desired. To this end, in one aspect of the present invention, the Internet server 12 enables communication as between Sales Agents and OFFICE for example via email broadcasts for the purpose of entering into referral arrangements. For example, in the real estate implementation of the present invention, the Internet server 12 can enable a form to be sent out by one Sales Agent to co-operating agents who are also connected to the Internet server 12.

Other variations and modifications of the invention are possible. For example, the database management facility 26 can be provided with means for supporting queries to a Sales Agent's data residing in the database 24 and generating and displaying a series of reports based on such data, in a manner that is known. Various other features can be associated with the web publication tool 30 that in turn enhance the features of the customized web page 35. For example, the web publication tool 30 may provide a client testimonial page at the customized web page 35, in a manner that is known. Additional features can be added to the system contemplated herein, without departing from the spirit of this invention. For example known tools for providing live feeds to access images of properties can be provided at the customized web site 35, in a manner that is known. All such modifications or variations are believed to be within the sphere and scope of the invention as defined by the claims appended hereto.

1) A method of generating sales over the Internet comprising:
a) Signing up one or more sales agent users for access to a server application executed on a web server, the web server being connected to the Internet;
b) Customizing and publishing a web site promoting goods or services using the server application, based on application of a plurality of web design selection tools to a plurality of web templates provided by the server application, whereby the web site includes a public area and an administration area;
c) Collecting contact data for customers and potential customers via the web site, whereby the contact data is stored to a database linked to the server application, and whereby the server application enables the one or more sales agent users to control access to their contact data; and
d) Creating customized sales tools by means of a sales tool facility provided by the server application, whereby the sales tools are customizable to promote sales based on a plurality of sales tool templates provided by the sales tool facility; and
e) Communicating the sales tools to one or more selected customers or potential customers via the server application.

2) The method of claim 1, further comprising the step of sending customized sales communications via the administration area, by operation of the sales tool facility, whereby the customized communications are based on a plurality of customizable communication templates provided by the server application, and customized by the one or more sales agent users.

3) The method of claim 1, further comprising the step of the one or more sales agent users initiating the creation of a client service report by operation of the sales tool facility, whereby the client service report lists a plurality of sales activities undertaken by one or more of the sales agent users in relation to one or more customers or potential customers selected by the one or more sales agent users.

4) The method claimed in claim 1, whereby the web templates and communication templates are updated by the operator of the web server to incorporate best practices for appealing to the target audience of the sales agent users' sales activities.

5) The method claimed in claim 1, whereby the server application enables the one or more sales agent users to design web sites dynamically by selecting in the administration area a plurality of design features corresponding to a particular web site design, and then previewing the web site design by means of a preview feature accessible via the admin area.

6) The method claimed in claim 1, whereby the server application and the database enable the one or more sales agent users to create a customer or potential customer list.

7) The method as claimed in claim 6, whereby the one or more sales agent users build the customer list by entering data into a form provided by the server application.

8) The method as claimed in claim 2, whereby the one or more sales agent users enter calendar information to a calendar facility provided by the server application, such that customized sales communications are delivered by the web server based on the calendar information.

9) The method as claimed in claim 8, whereby the sales tool facility and calendar facility cooperate to provide the client service report that lists the activities of one or more of the sales agent users by reference to the calendar data entered to the calendar facility.

10) The method as claimed in claim 1, comprising the further step of the one or more sales agent users offering incentives to customers and potential customers to provide their contact data to the customized web site by operation of the customized web site.

11) The method as claimed in claim 2, further comprising the step of the one or more sales agent users sending customized e-cards using the e-card facility included in the sales tool facility, whereby the e-card facility enables the one or more sales agent users to select between a plurality of e-card templates designed to appeal to the target audience of the one or more sales agent users' sales activities.

12) The method as claimed in claim 1, further comprising the step of promoting the customized web site on the Internet by initiating the server application to establish search engine positioning of the customized web site.

13) An Internet sales generation system comprising:
a) A server computer, linked to the Internet, and being further linked to a server application executable on the server computer, the server computer being linked to a database, the server application including:
i) An administration facility that enables the operator of the server computer to manage access to the server application by a plurality of sales agent users;
ii) A web publication facility that enables the plurality of sales agent users to customize and publish a customized web site promoting goods or services based on application of a plurality of web design selection tools to a plurality of web templates, the customized web site enabling the collection of contact data of customers and potential customers;
iii) A database management facility linked to the database, the database management facility enabling the management of the contact data on the database, wherein the database management facility enables the plurality of sales agent users to restrict access to their contact data to only other users selected by each of the plurality of sales agent users;
iv) A sales tool facility that enables the plurality of sales agent users to create customized sales tools, wherein the sales tools are customizable to promote sales based on a plurality of sales tool templates provided by the sales tool facility; and
v) A communication facility, including an email facility, that enables the plurality of sales agent users to send email communications to third parties including the customers and potential customers, wherein the email communications include customized sales tools.

14) The system claimed in claim 13, wherein the sales tool facility and email facility cooperate to enable the plurality of sales agent users to send customized sales communications whereby customized communications are based on a plurality of customizable communication templates provided by the sales tool facility.

15) The system as claimed in claim 13, wherein the sales tool facility enables the plurality of sales agent users to create a client service report that lists a plurality of sales activities undertaken by one or more of the plurality of sales agent users in relation to one or more customers or potential customers selected by the one or more of the plurality of sales agent users.

16) The system as claimed in claim 13, wherein the web templates and communication templates are updated by the operator of the server computer to incorporate best practices for appealing to the target audience of the plurality of sales agent users' sales activities.

17) The system as claimed in claim 13, wherein the web publication facility enables the plurality of sales agent users to design web sites dynamically by selecting a plurality of design features corresponding to a particular web site design, and then previewing the web site design by means of a preview feature provided by the web publication facility.

18) The system as claimed in claim 13, wherein the database management utility enables the plurality of sales agent users to create a customer list.

19) The system as claimed in claim 18, wherein the plurality of sales agent users build the customer list by entering data into a form provided by the server application.

20) The system as claimed in claim 13, wherein the server application further includes a calendar facility that enables the plurality of sales agent users to add calendar data, and the calendar facility, sales tool facility and email facility cooperate such that customized sales communications are delivered by the server computer based on the calendar information.

21) The system claimed in claim 20, wherein the sales tool facility and calendar facility cooperate to provide the client service report that lists the activities of one or more of the plurality of sales agent users by reference to the calendar data entered to the calendar facility.

22) The system as claimed in claim 13, wherein the sales tool facility and email facility enable the plurality of sales agent users to send customized e-cards based on an e-card facility included in the sales tool facility, whereby the e-card facility enables the plurality of sales agent users to select between a plurality of e-card templates designed to appeal to the target audience of the plurality of sales agent users' sales activities.

23) The system as claimed in claim 13, wherein the web publication facility enables promotion of the customized web site on the Internet by initiating establishing search engine positioning into the programming of the customized web site.

24) The system claimed in claim 13, wherein the database management facility enables one or more of the plurality of sales agent users to share their contact data with one or more other selected sales agent users.

25) The system claimed in claim 13, wherein the administration facility enables an administrative user to define the parameters of a network of linked customized web pages corresponding to one or more associated sales agent users, and to define the parameters whereby contact data is shared between the one or more associated sales agent users.

26) A computer program product, executable on a server computer, wherein the computer program product is adapted to instruct the server computer to process operations providing:
a) An administration facility that enables the operator of the server computer to manage access to the server application by a plurality of sales agent users;
b) A web publication facility that enables the plurality of sales agent users to customize and publish a customized web site promoting goods or services based on application of a plurality of web design selection tools to a plurality of web templates, the customized web site enabling the collection of contact data of customers and potential customers;
c) A database management facility linked to the database, the database management facility enabling the management of the contact data on the database, wherein the database management facility enables the plurality of sales agent users to restrict access to their contact data to only other users authorized by the one or more of the plurality of sales agent users;
d) A sales tool facility that enables the plurality of sales agent users to create customized sales tools, wherein the sales tools are customizable to promote sales based on a plurality of sales tool templates provided by the sales tool facility; and
e) A communication facility, including an email facility, that enables the plurality of sales agent users to send email communications to third parties including the customers and potential customers, wherein the email communications include customized sales tools.

27) A computer program product, executable on a computer, wherein the computer program product is adapted to instruct the computer to process operations related to providing:
a) A web publication facility that enables one or more sales agent users to customize and publish to an Internet server a customized web site promoting goods or services based on application of a plurality of web design selection tools to a plurality of web templates, the customized web site enabling the collection of contact data of customers and potential customers;
b) A database management facility linked to a remote database, the database management facility enabling the management of the contact data on the database, wherein the database management facility enables the one or more sales agent users to restrict access to their contact data to only other users authorized by the one or more sales agent users;
c) A sales tool facility that enables the one or more sales agent users to create customized sales tools, wherein the sales tools are customizable to promote sales based on a plurality of sales tool templates provided by the sales tool facility; and
A communication facility linked to the Internet server and including an email facility, that enables the one or more sales agent users to send email communications to third parties including the customers and potential customers, wherein the email
